(19) United States
(12) Patent Application Publication
(10) Pub. No.: US 2005/0004848 A1
(43) Pub. Date: Jan. 6, 2005

(54) Method of real-time on-line auction processing

(76) Inventors: Yan-Mei Tang-Talpin, Saint Gregoire (FR); Christophe Laurent, Vignoc (FR); Sylvain Lelievre, Montgermont (FR)

Correspondence Address: THOMSON MULTIMEDIA LICENSING INC;JOSEPH S TRIPOLI, PO BOX 5312, 2 INDEPENDENCE WAY, PRINCETON, NJ, 08543-5312, US

(21) Appl. No.: 10/883,598

(22) Filed: Jul. 1, 2004

(30) Foreign Application Priority Data
Jul. 3, 2003 (FR) 0308116

(51) Int. Cl. G06F 17/60

(52) U.S. Cl. 705/26

(57) ABSTRACT

The present invention relates to a method of real-time on-line auction processing implemented by a bid server, comprising the following steps: reception of bid orders relating to at least one good or service put up for sale by auction, each bid order being associated with an amount; selection of a bid order, from among the bid orders received whose amount is equal to the highest amount of all the bid orders received. Furthermore, in this method a timeout is triggered whenever the server receives a bid order of an amount strictly greater than the highest amount of all the bid orders received previously and relating to the said good or service; and during the selection step, a bid order is selected randomly from among those received during the timeout period. The invention applies also to two other types of auction methods in which the price of the good or service put up for sale is fixed by the server.

The present invention relates to a method of real-time on-line auction processing.

More precisely, the invention relates to a method of real-time on-line auction processing implemented by a bid server, of the type comprising the following steps:
reception of bid orders relating to a good or service put up for sale by auction, each bid order being associated with an amount;
selection of a bid order, from among the bid orders received whose amount is equal to the highest amount of all the bid orders received.

Such a method is described in document WO 99/27476. It concerns a method of real-time on-line auction processing implemented by a server receiving bid orders relating to a good or service put up for sale by auction. As soon as the server receives a bid order whose amount is strictly greater than the amount of the previous bid selected, the server selects this bid order.

In this method, when a user bids, the bid order that he sends to the bid server travels via a data transmission network of the Internet type. Now, the Internet network guarantees neither the duration of transmission (variable depending on the users' connection bit rate), nor the proper receipt of the bid order.

It may therefore happen that the order of receipt of two bid orders by the bid server is the reverse of the order of issue by two different terminals, if the bid orders were issued at very closely spaced instants.

Now, in the current state of the art, it is impossible to determine which of the two bid orders was issued first since it is very difficult to synchronize the clocks of the terminals used by the users.

Document WO 99/27476 pinpoints this problem, but simply specifies that the loss of a message and the variable period of transmission of this message are random items that have to be taken into consideration by the users before participating in the bidding.

This method may therefore create unfairness by favouring the users who have a high bit rate connection.

An aim of the invention is to remedy this drawback by providing a method of auction processing allowing the bid orders to be processed more equitably, that is to say without systematically disadvantaging the users who benefit from a low bit rate connection only.

To this end, the subject of the invention is a method of real-time on-line auction processing implemented by a bid server of the aforesaid type, characterized in that:
a timeout is triggered whenever the server receives a bid order of an amount strictly greater than the highest amount of all the bid orders received previously and relating to the said good or service; and
during the selection step, a bid order is selected randomly from among those received during the timeout period.

A method of auction processing according to the invention allows equal processing of the bid orders received, regardless of the user and his connection. If two bid orders of the same amount have been received during the timeout period, each bid order has a chance of being selected by the server. Thus, all the users whose bid orders are received by the server during the timeout period are processed on an equal footing, regardless of their type of connection.

A method of auction processing according to the invention can furthermore comprise one or more of the following characteristics:
the putting of the said good or service up for sale is closed at the end of a predetermined sale period, this period being measured from the receipt of the first bid order, the good or service put up for sale then being allotted to the last bid order randomly selected;
the putting of the said good or service up for sale is closed at the end of a predetermined sale period, this period being measured from the receipt of the last bid order, the good or service put up for sale then being allotted to the issuer of the last bid order randomly selected; and
the validity of the bid orders is ensured by a procedure for signing the bid orders using a message authentication code.

The invention also relates, according to a first variant, to a method of real-time on-line auction processing implemented by a bid server, comprising the following steps:
(a) fixing by the server of an amount associated with a good or service put up for sale by auction;
(b) reception of bid orders relating to this good or service in respect of an amount corresponding to the amount fixed by the server;
(c) selection of a bid order from among the bid orders received and then return to step (a) for the fixing of a higher amount associated with the good or service put up for sale.

This method is characterized in that
a timeout is triggered whenever the server receives a first bid order associated with the amount fixed by the server; and
during the selection step, a bid order is selected randomly from among those received during the timeout period.

According to a particular characteristic of this method, the putting of the said good or service up for sale is closed when no bid order is received by the server following the fixing of a new higher amount, the good or service put up for sale then being allotted to the issuer of the last bid order randomly selected.

The invention also relates, according to a second variant, to a method of real-time on-line auction processing implemented by a bid server, comprising the following steps:
(a) fixing by the server of an amount associated with a good or service put up for sale by auction;
(b) awaiting by the server of reception of a bid order relating to this good or service in respect of an amount corresponding to the amount fixed by the server, and
   if no bid order is received during a predetermined period, then return to step (a) for the fixing of a lower amount associated with the good or service put up for sale,
   otherwise, selection of a bid order from among the bid orders received.

This method is characterized in that:
a timeout is triggered whenever the server receives a first bid order associated with the amount fixed by the server; and
during the selection step, a bid order is selected randomly from among those received during the timeout period.

### BRIEF DESCRIPTION OF THE DRAWINGS

The invention will be better understood on reading the description which follows, given merely by way of example and while referring to the appended drawings in which:

FIG. 1 diagrammatically represents a system adapted for the implementation of a method according to the invention;

FIG. 2 is a flowchart representing the various steps of a method according to the invention;

FIG. 3 is a time chart symbolizing a sale by auction using a method according to the invention;

FIG. 4 is a diagram detailing a method of secure exchanges implemented by the system of FIG. 1.

### DETAILED DESCRIPTION OF THE INVENTION

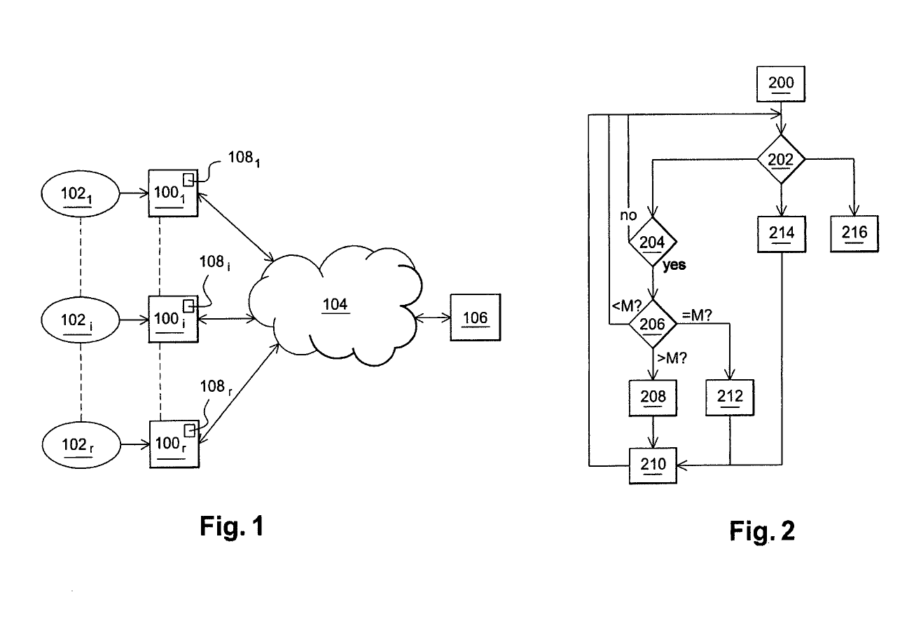

The system represented in FIG. 1 comprises r terminals 100₁, 100₂, . . . , 100ᵣ, for example personal computers.

These terminals 100₁, 100₂, . . . , 100ᵣ are used by r bidders 102₁, 102₂, . . . , 102ᵣ to ascertain the information of the auction in progress and to issue bid orders. To do this, the terminals 100₁, 100₂, . . . , 100ᵣ have means for displaying the bid information.

These terminals 100₁, 100₂, . . . , 100ᵣ are linked to a data transmission network 104, for example the Internet network.

A bid server 106 is used to manage auction sales, that is to say to send the terminals 100₁, 100₂, . . . , 100ᵣ the information relating to the auction in progress (designation of the good, name of the seller, amount of the last bid order selected relating to this good, period remaining, etc.), and to process the bid orders placed by the bidders 102₁, 102₂, . . . , 102ᵣ. To be recognized by the server 106, each bidder must register before the start of an auction sale with a trusted third party (or TTP) which manages the server 106. An individual identifier Id₁, Id₂, . . . , Idᵣ, is generated during this registration phase for each terminal by the trusted third party and is then transmitted by the server 106 in a secure manner to each terminal which stores it in a memory area 108₁, 108₂, . . . , 108ᵣ.

The method of auction processing represented in FIG. 2 is implemented by the bid server 106.

This method uses two timeouts. A first timeout, individual to the invention, of period D of the order of a few seconds, resolves cases of conflicts between bid orders received at very closely spaced instants. The role of this timeout will be specified later. The second timeout of period D_{E}, which varies from a few minutes to a few tens of minutes, characterizes the limit period after which the server 106 closes the bid if it has not received any new bid order since the previous one.

During a step 200, the server 106 initializes the amount of an object put up for sale at a value M₀. In what follows, the current amount of the bid will be denoted M. The server 106 also fixes the period D_{E} and the period D of the two timeouts.

During a step 202, the server 106 continuously tests whether one of the two timeouts has elapsed and whether it receives a new bid order.

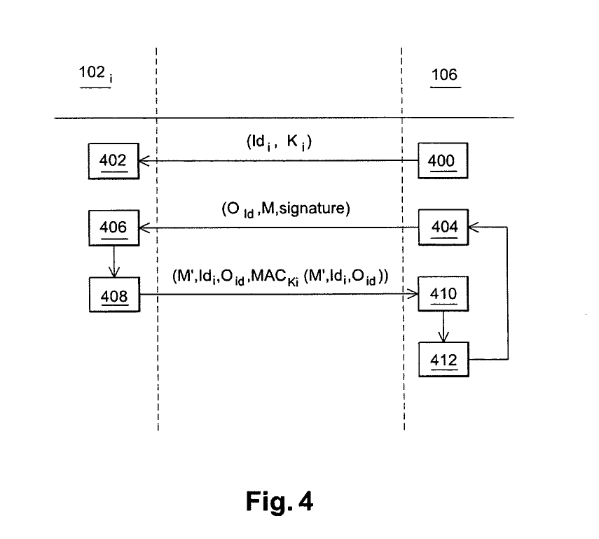

If a new bid order has been received during step 202, the server 106 tests the validity of this bid order during a step 204. The validity of the bid orders is ensured by a procedure for signing the bid orders using a message authentication code. This procedure will be described later with reference to FIG. 4.

If the bid order has been validated during step 204, the server S triggers the timeout of period D_{E} and compares the value of the amount of the new bid order with the value M of the current bid during a step 206.

Otherwise, we go to step 202.

If during step 206, the server 106 notes that the amount of the new bid order is strictly greater than the current bid M, then the server triggers the timeout of period D during a step 208 and fixes the value of the current amount M of the bid at the amount of the new bid order. It then also initializes a variable Datum_bid. This variable Datum_bid keeps in memory the identifiers of all the bidders who have placed a bid order whose amount is equal to M, that is to say to the largest amount of all the bid orders received.

During a step 210 following step 208, the server 106 issues the updated information relating to the bid to all the terminals 100₁, . . . , 100ᵣ. This information includes among other things the current amount M of the bid, and possibly the identifier of the user whose bid order is temporarily selected.

After step 210, we return to step 202.

During step 206, if the server 106 notes that the amount of the new bid order is equal to the current bid M, it then updates the variable Datum_bid in a step 212 by adding the identifier of the user who has just placed the new bid order. We then go to step 210.

If during step 206, the server 106 notes that the amount of the new bid order is strictly lower than the amount M of the current bid, we return to step 202.

If the bid order has not been validated during step 204, we return to step 202.

If during step 202 the timeout of the server 106 corresponding to the period D has elapsed, it then chooses randomly in the course of a step 214, one of the users whose identifier is stored in the variable Datum_bid, that is to say one of the users who has issued a bid order of amount M, received during the timeout period D. In practice, this random selection is implemented by virtue of conventional pseudo-random means of selection. We then go to step 210.

If during step 202, the server 106 detects that the timeout relating to the variable D_{E} has elapsed, it then issues, during a step 216, the final information relating to the bid to all the terminals and closes the auction sale. This information includes among other things the identifier of the winner as well as the amount of the final bid.

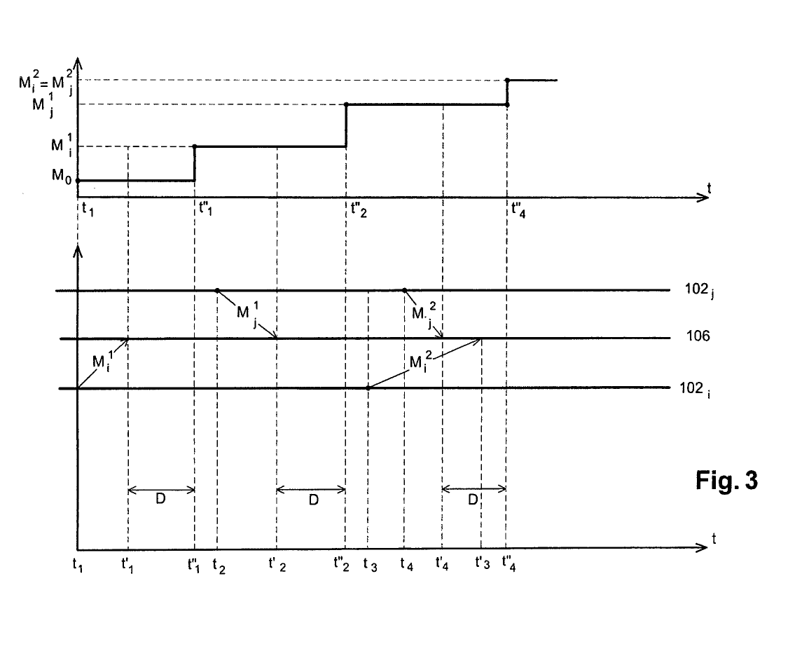

FIG. 3 represents an example of an auction sale using the method described above and in the course of which two bidders 102ᵢ and 102ⱼ issue bid orders with regard to the same object.

The two bidders 102ᵢ et 102ⱼ follow the auction in real time with the aid of the two terminals 100ᵢ and 100ⱼ.

The terminals 100ᵢ and 100ⱼ being remote from the server 106, there is a variable duration of transmission of the information to the server 106 and in particular of the bid orders. The instant at which a user places his bid order is therefore separate from the instant at which the server 106 receives this bid order. The duration between these two instants may vary over time as a function of the congestion of the network and also varies as a function of each user's connection bit rate.

Let Mᵢ¹ be the amount of a first bid order issued by the user 102ᵢ at an instant T₁. The bid server 106 receives this bid order at the instant t′₁. According to the method described above, the server 106 then triggers the timeout of period D at the instant t′₁. When the timeout has elapsed, and in the absence of other bid orders received by the bid server 106 in the course of this period D, the server 106 selects, at the instant t″₁, the bid order from the bidder 102ᵢ for an amount Mᵢ¹. The instant t″₁, is equal to t′₁+D.

The server 106 thereafter receives at the instant t′₂ a bid order of amount Mⱼ¹ issued at the instant t₂ by the user 102ⱼ, Mⱼ¹ being strictly greater than Mᵢ¹. Thereafter, the server 106 allots the bid to the user 102ⱼ at the instant t″₂=t′₂+D.

At the instant t₃, the bidder 102ᵢ issues a bid order of amount Mᵢ². This bid order will be received by the server 106 at the instant t′₃

The bidder 102ⱼ thereafter issues a bid order of amount Mⱼ² equal to Mᵢ² at the instant t₄ greater than t₃. This bid order is received by the server 106 at the instant t′₄ less than the instant t′₃, thereby triggering the timeout of period D. The typical case then transpires in which two bid orders of identical amounts have been placed by two bidders, and in which the order of receipt by the server S of the two bid orders is the reverse order to the actual order of issue by the two users 102ᵢ and 102ⱼ.

According to the method described above, on completion of the timeout of period D, that is to say at the instant t″₄, the server 106 determines in a random manner which of the two users 102ᵢ and 102ⱼ will be allotted the bid at the amount Mⱼ²=Mᵢ².

FIG. 4 describes the way in which the exchanges between the bid server 106 and the terminals 100₁, . . . , 100ᵣ of the users are made secure.

The server is managed by a trusted third party and possesses a pair of asymmetric keys PK and SK in which PK is a public key and SK is a private key which it keeps secret and which allows it to decrypt the messages encrypted with PK. All the terminals 100₁, . . . , 100ᵣ participating in a sale by auction therefore have knowledge of the key PK.

The server also possesses a master key MK that it keeps secret.

During a step 400, the trusted third party generates for each user the identifiers Id₁, Id₂, . . . , Idᵣ as well as a secret key K₁, K₂, . . . , Kᵣ. The secret keys K₁, K₂, . . . , Kᵣ derive from the master key MK and from the identifiers Id₁, Id₂, . . . , Idᵣ with the aid of a function F (for example the function SHA): Kᵢ=F(MK, Idᵢ).

These identifiers Id₁, Id₂, . . . , Idᵣ as well as these keys K₁, K₂, . . . , Kᵣ are thereafter sent by the server 106 to each terminal 100₁, . . . ,100ᵣ concerned.

During a step 402, the terminals receive and store the identifiers Id₁, Id₂, . . . , Idᵣ as well as the keys K₁, K₂, . . . , Kᵣ in the memory areas 108₁, 108₂, . . . , 108ᵣ.

The auction sale begins with a step 404 during which the server generates a message containing the current amount M of the object put up for sale by auction as well as its identifier O_{Id}. This message is signed electronically by the bid server with the aid of its private key SK.

This message is thereafter issued to all the terminals of the users participating in the auction relating to the object put up for sale.

After receipt of this message, each terminal verifies the signature in a step 406, using the public key PK.

If a user 102ᵢ wishes to bid, he creates, during a step 408, a message containing among other things an amount M′ of his new bid order, his own identifier Idᵢ, as well as the identifier O_{Id} of the object put up for sale. A message authentication code is generated with the aid of these three items of information and of the secret key Kᵢ that he possesses: MAC_{Ki}(O_{id},M′,Idᵢ). This message authentication code is an electronic seal produced by an algorithm using the derived secret key Kᵢ and making it possible to guarantee the integrity of the message on arrival. All these items of information are thereafter sent to the server 106.

During a step 410, the server 106, with the aid of the identifier Idᵢ of the user who has bid, generates the secret key Kᵢ of the user as well as the message authentication code.

The comparison of the authentication code thus obtained with the authentication code received allows it to validate or otherwise the bid order of the user 102ᵢ.

During a step 412, the bid server 106 updates the information relating to the current bid, by following the method of the invention.

Thereafter, we go to step 404 again.

It is clearly apparent that the method described above allows equal processing of the bid orders received, regardless of the type of connection of the users.

It will be noted that the invention is not limited to the bidding system example which has been described, in particular in conjunction with FIG. 3, and in which the bidders raise the price of the object put up for sale.

The invention applies equally to a system in which it is the server that raises the price of the object put up for sale. The server fixes a price at the start as in the previous example. The bidders who accept the price then respond and a timeout is triggered when the server receives the first acceptance of the price from a bidder. The server thereafter randomly selects a bidder who has accepted the price from among the responses received during the timeout period, then fixes a new higher price, doing so until it no longer receives any response accepting the new price in which case it allots the good put up for sale to the last bidder randomly selected.

The invention applies also to another bidding system in which the server initially proposes a high reserve price and waits a predetermined period for at least one bidder to accept this offer. When it receives an acceptance from a bidder, the server triggers a timeout and it then randomly selects a bidder who has accepted the price from among those that responded during the timeout period. If the server receives no response during the predetermined period, it lowers the price, doing so until one bidder at least accepts the price or until the end of the auction if nobody accepts the lowest price proposed by the server.

1. Method of real-time on-line auction processing implemented by a bid server, comprising the following steps:
reception of bid orders relating to a good or service put up for sale by auction, each bid order being associated with an amount;
selection of a bid order, from among the bid orders received whose amount is equal to the highest amount of all the bid orders received; wherein:
a timeout is triggered whenever the server receives a bid order of an amount strictly greater than the highest amount of all the bid orders received previously and relating to the said good or service; and
during the selection step, a bid order is selected randomly from among those received during the timeout period.

2. Method of auction processing according to claim 1, in which the putting of the said good or service up for sale is closed at the end of a predetermined sale period, this period being measured from the receipt of the first bid order, the good or service put up for sale then being allotted to the issuer of the last bid order randomly selected.

3. Method of auction processing according to claim 1, in which the putting of the said good or service up for sale is closed at the end of a predetermined sale period, this period being measured from the receipt of the last bid order, the good or service put up for sale then being allotted to the issuer of the last bid order randomly selected.

4. Method of auction processing according to Claim 1, in which the validity of the bid orders is ensured by a procedure for signing the bid orders using a message authentication code.

5. Method of real-time on-line auction processing implemented by a bid server, comprising the following steps:
(a) fixing by the server of an amount associated with a good or service put up for sale by auction;
(b) reception of bid orders relating to this good or service in respect of an amount corresponding to the amount fixed by the server;
(c) selection of a bid order from among the bid orders received and then return to step (a) for the fixing of a higher amount associated with the good or service put up for sale;
a timeout is triggered whenever the server receives a first bid order associated with the amount fixed by the server; and
during the selection step, a bid order is selected randomly from among those received during the timeout period.

6. Method of auction processing according to claim 5, in which the putting of the said good or service up for sale is closed when no bid order is received by the server following the fixing of a new higher amount, the good or service put up for sale then being allotted to the issuer of the last bid order randomly selected.

7. Method of real-time on-line auction processing implemented by a bid server, comprising the following steps:
(a) fixing by the server (106) of an amount associated with a good or service put up for sale by auction;
(b) awaiting by the server of reception of a bid order relating to this good or service in respect of an amount corresponding to the amount fixed by the server, and
if no bid order is received during a predetermined period, then return to step (a) for the fixing of a lower amount associated with the good or service put up for sale,
otherwise, selection of a bid order from among the bid orders received;
a timeout is triggered whenever the server receives a first bid order associated with the amount fixed by the server; and
during the selection step, a bid order is selected randomly from among those received during the timeout period.
